(19) United States
(12) Patent Application Publication
(10) Pub. No.: US 2016/0053709 A1
(43) Pub. Date: Feb. 25, 2016

(54) CYLINDER LINER ASSEMBLY HAVING THERMAL BARRIER

(71) Applicant: CATERPILLAR INC., Peoria, IL (US)

(72) Inventors: Christopher Lee BATTA, West Lafayette, IN (US); Nathan Roger BJERK, Chillicothe, IL (US)

(73) Assignee: CATERPILLAR INC., Peoria, IL (US)

(21) Appl. No.: 14/463,277

(22) Filed: Aug. 19, 2014

(51) Int. Cl. F02F 1/00; F02F 11/00; F02F 1/02

(52) U.S. Cl. CPC F02F 1/004; F02F 1/02; F02F 11/005

(57) ABSTRACT

A cylinder liner assembly is disclosed for use with an engine. The cylinder liner assembly may have a liner with a hollow generally cylindrical body extending from a top end to a bottom end along a longitudinal axis, and an internal recess formed at the top end. The cylinder liner assembly may also have an anti-polishing ring disposed within the internal recess at the top end of the liner, and a seal disposed around the liner at an internal axial end of the anti-polishing ring. A surface roughness of the internal recess, together with a surface roughness of the anti-polishing ring, may create a thermal barrier configured to maintain a desired temperature of the seal.

### TECHNICAL FIELD

The present disclosure relates generally to a cylinder liner assembly and, more particularly, to a cylinder liner assembly having a thermal barrier.

### BACKGROUND

An internal combustion engine includes an engine block defining a plurality of cylinder bores, and pistons that reciprocate within the cylinder bores to generate mechanical power. Typically, each cylinder bore includes a replaceable liner. The liner has a cylindrical body that fits within the cylinder bore, and a radial flange at a top end of the body that supports the cylinder liner on the engine block. In some embodiments, a cavity is formed within the cylinder block around the liner, and coolant is directed through the cavity to cool the liner. A seal is placed around the liner and against the flange to inhibit coolant from leaking out of the cavity.

In some applications, an anti-polishing ring is fitted into an upper end of the liner at the flange. The anti-polishing ring has an inner diameter that is slightly smaller than an inner diameter of the liner, and functions to scrape carbon deposits off a top of the associated piston. The carbon deposits, if left intact could eventually rub against the liner, polishing away oil retaining grooves in the liner. An exemplary anti-polishing ring is disclosed in U.S. Pat. No. 5,553,585 that issued to Paro on Sep. 10, 1996.

Although an anti-polishing ring may be effective at removing carbon buildup from a piston, it may also be possible for too much heat to pass through the ring to the seal. In these situations, the seal could overheat and turn brittle or crack. When the integrity of the seal is compromised, coolant from the cavity below the seal may leak out of the engine block. This could cause overheating of the engine, contamination of other engine fluids (e.g., of engine oil), corrosion, and other similar problems.

The cylinder liner assembly of the present disclosure solves one or more of the problems set forth above and/or other problems in the art.

### SUMMARY

In one aspect, the present disclosure is directed to a cylinder liner assembly. The cylinder liner assembly may include a liner with a hollow generally cylindrical body extending from a top end to a bottom end along a longitudinal axis, and an internal recess formed at the top end. The cylinder liner assembly may also include an anti-polishing ring disposed within the internal recess at the top end of the liner, and a seal disposed around the liner at an internal axial end of the anti-polishing ring. A surface roughness of the internal recess, together with a surface roughness of the anti-polishing ring, may create a thermal barrier configured to maintain a desired temperature of the seal.

In another aspect, the present disclosure is directed to another cylinder liner assembly. This cylinder liner assembly may include a liner having a hollow generally cylindrical body extending from a top end to a bottom end along a longitudinal axis and a radial thickness of about 10-25 mm, an internal recess formed at the top end, a flange connected to the hollow generally cylindrical body at the top end, and a coolant reservoir formed at an inside corner between the flange and the hollow generally cylindrical body. The cylinder liner assembly may also include an anti-polishing ring disposed within the internal recess at the top end of the liner and having a thickness of about 1-4 mm, and a seal disposed around the liner at an internal axial end of the anti-polishing ring. A first surface roughness at an inner annular surface of the internal recess may be about 6-9 μm, and a second surface roughness at an outer annular surface of the anti-polishing ring that engages the inner annular surface may be about 3-3.5 μm. The first and second surface roughnesses create a thermal barrier having a contact resistance of about 0.1-0.5 m²° C./kW.

In yet another aspect, the present disclosure is directed to an engine. The engine may include a cylinder block at least partially defining a plurality of cylinder bores, a cylinder liner assembly disposed within each of the plurality of cylinder bores, and a water jacket formed between an annular wall of each cylinder liner assembly and a corresponding one of the plurality of cylinder bores. Each cylinder liner assembly may include a liner having a hollow generally cylindrical body extending from a top end to a bottom end along a longitudinal axis, an internal recess formed at the top end, a flange connected to the hollow generally cylindrical body at the top end and configured to engage the cylinder block, and a coolant reservoir formed at an inside corner between the flange and the hollow generally cylindrical body. Each cylinder liner assembly may also include an anti-polishing ring disposed within the internal recess at the top end of the liner, and a seal disposed around the liner at an internal axial end of the anti-polishing ring, between the water jacket and the coolant reservoir. A surface roughness of the internal recess together with a surface roughness of the anti-polishing ring may create a thermal barrier configured to maintain a desired temperature of the seal and to inhibit boiling of coolant within the coolant reservoir.

### BRIEF DESCRIPTION OF THE DRAWINGS

FIG. 1 is a cross-sectional illustration of an exemplary disclosed engine;

FIG. 2 is an isometric illustration of an exemplary disclosed cylinder liner assembly that may be used in conjunction with the engine of FIG. 1; and

FIG. 3 is a cross-sectional illustration of a portion of the cylinder liner assembly of FIG. 2.

### DETAILED DESCRIPTION

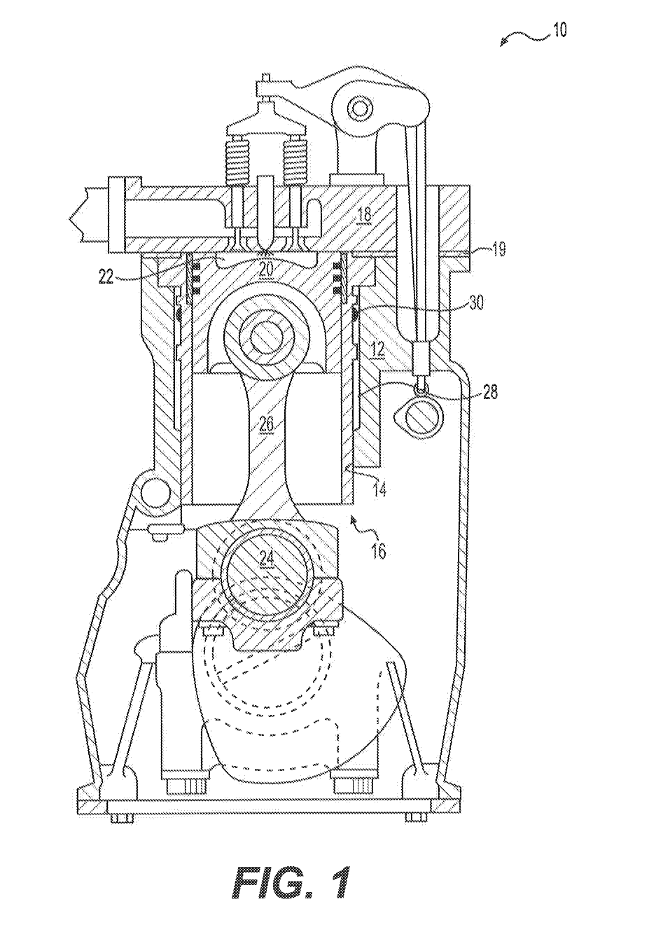

FIG. 1 illustrates a portion of an exemplary internal combustion engine 10. Engine 10 may include an engine block 12 defining at least one cylinder bore 14. A cylinder liner assembly 16 may be disposed within cylinder bore 14, and a cylinder head 18 may be connected to engine block 12 to close off an end of cylinder bore 14 (e.g., by way of a head gasket 19). A piston 20 may be slidably disposed within cylinder liner assembly 16, and piston 20 together with cylinder liner assembly 16 and cylinder head 18 may define a combustion chamber 22. It is contemplated that engine 10 may include any number of combustion chambers 22 and that combustion chambers 22 may be disposed in an “in-line” configuration, in a “V” configuration, in an opposing-piston configuration, or in any other suitable configuration.

Piston 20 may be configured to reciprocate within cylinder liner assembly 16 between a top-dead-center (TDC) position and a bottom-dead-center (BDC) position to facilitate a combustion process with chamber 22. In particular, piston 20 may be pivotally connected to a crankshaft 24 by way of a connecting rod 26, so that a sliding motion of each piston 20 within cylinder liner assembly 16 results in a rotation of crankshaft 24. Similarly, a rotation of crankshaft 24 may result in a sliding motion of piston 20. In a two-stroke engine, piston 20 may move through two full strokes to complete a combustion cycle that includes a power/exhaust/intake stroke (TDC to BDC) and an intake/compression stroke (BDC to TDC). In a four-stroke engine, piston 20 may move through four full strokes to complete a combustion cycle that includes an intake stroke (TDC to BDC), a compression stroke (BDC to TDC), a power stroke (TDC to BDC), and an exhaust stroke (BDC to TDC). Fuel (e.g., diesel fuel, gasoline, gaseous fuel, etc.) may be injected into combustion chamber 22 during the intake strokes of either combustion cycle. The fuel may be mixed with air during the compression strokes and ignited. The heat and pressure resulting from the fuel/air ignition may then be converted to useful mechanical power during the ensuing power strokes. Residual gases may be discharged from combustion chamber 22 during the exhaust strokes.

Heat from the combustion process described above that could damage engine 10, if unaccounted for, may be dissipated from cylinder bore 14 by way of a water jacket 28. Water jacket 28 may be located between an internal wall of cylinder bore 14 and an external wall of cylinder liner assembly 16. For example, water jacket 28 may be formed by a recess within engine block 12 at the internal wall of cylinder bore 14 and/or within the external wall of cylinder liner assembly 16. It is contemplated that water jacket 28 may be formed completely within engine block 12 around cylinder liner assembly 16, formed completely within cylinder liner assembly 16, and/or formed by a hollow sleeve (not shown) that is brazed to either one of engine block 12 or cylinder liner assembly 16, as desired. Water, glycol, or a blended mixture may be directed through water jacket 28 to absorb heat from engine block 12 and cylinder liner assembly 16.

A seal 30 may be disposed around cylinder liner assembly 16 to seal off an upper end of water jacket 28. Seal 30 may be sandwiched between an outer wall of cylinder liner assembly 16 and an inner wall of cylinder bore 14, after assembly, such that coolant within water jacket 28 is inhibited from leaking out of engine block 12 through a top of cylinder bore 14. Seal 30 may be, for example, an o-ring type seal fabricated from a resilient material.

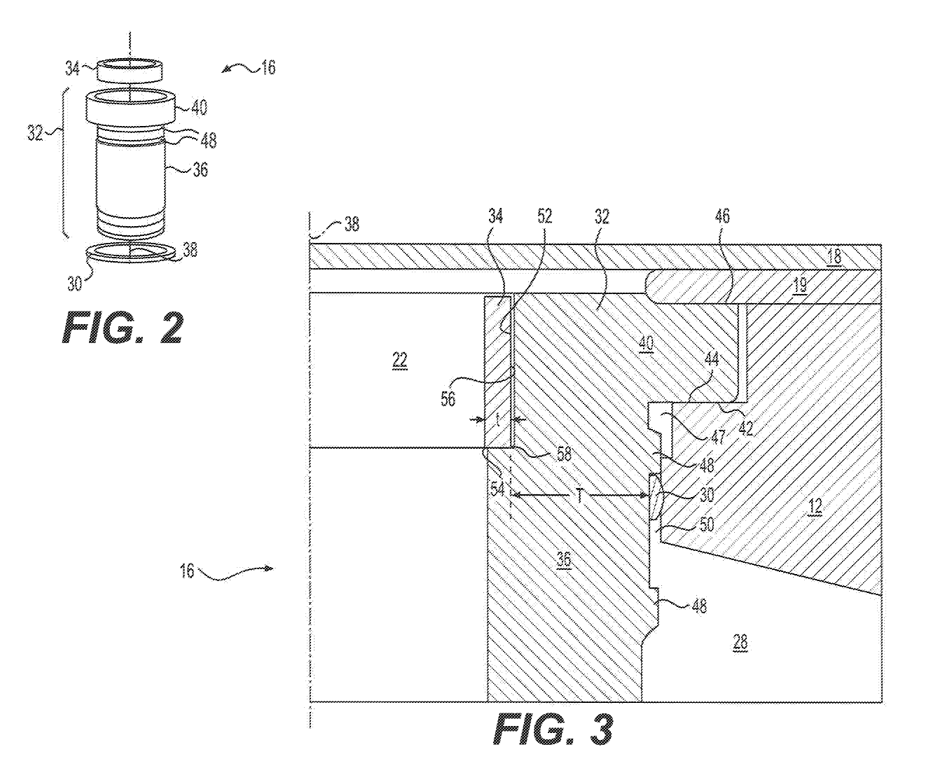

As shown in FIGS. 2 and 3, cylinder liner assembly 16 may be an assembly of at least two main components, including a cylinder liner (“liner”) 32 and an anti-polishing ring or cuff (“ring”) 34 (i.e., together with seal 30). Each of liner 32 and ring 34 may be made of the same general material, for example from an alloyed gray iron. Ring 34 may be fitted into an upper or external end of liner 32 prior to assembly of cylinder liner assembly 16 into cylinder bore 14 of engine block 12. In this position, ring 34 may be configured to receive a top land of piston 20 (referring to FIG. 1). In particular, the top end of piston 20 may slide into ring 34 a distance during each upward stroke that allows ring 34 to scrape away any carbon deposits that have built up on the outer annular surface of piston 20 at a location above any associated piston rings. By scraping away the carbon deposits, the life of engine 10 may be extended.

Liner 32 may have a hollow generally cylindrical body 36 extending along a longitudinal axis 38, and an annular flange 40 protruding radially outward at a top or exposed end of body 36. A lower face 42 of flange 40 may be configured to engage an upper face of 44 of engine block 12, while an upper face 46 of flange 40 may be configured to engage gasket 19. An annular recess or groove 47 may be formed under flange 40 (i.e., at an inside corner of body 36 and flange 40) to function as an overflow or backup coolant collection cavity. In particular, any coolant that leaks from water jacket 28 past seal 30 may be collected within recess 47, and the engagement of lower face 42 with upper face 44 may inhibit this collected coolant from escaping recess 47.

Seal 30 may be retained at a desired axial location on liner 32 (e.g., at an inner axial end of ring 34) by end stops 48 located at opposing sides of seal 30. Water jacket 28 may fluidly communicate with a lower half of seal 30 via an annular passage 50 formed by a difference of liner and bore diameters at an axial location between end stops 48. This communication may help to cool seal 30.

An internal annular recess 52 may be formed at the top end of body 36 and configured to receive ring 34. Recess 52 may have a surface finish produced via a grinding process to have a roughness of about 6-10 μm (e.g., about 6-9 μm). A radial thickness T of liner 32 between recess 52 and seal 30 may be about 10-25 mm.

Ring 34 may be fitted into recess 52, and have an internal diameter less than an internal diameter of body 36, and a thickness t of about ⅙- 1/10 of the thickness T (e.g., 1-4 mm). With this configuration, a step 54 may be created that interacts with piston 20 to scrape away the carbon buildup described above. Ring 34 may extend axially from the exposed end of body 36 downward past recess 47 to the upper end stop 48. An outer annular surface 56 of ring 34 may have a surface finish produced via a grinding process to have a roughness of about ⅓-½ of the roughness of recess 52. For example, surface 56 may have a roughness of about 2-6 μm (e.g., about 3-3.5 μm).

The surface finish of ring 34, when combined with the surface finish of recess 52, may produce a thermal barrier 58 that inhibits heat transfer from combustion chamber 22 to seal 30 and recess 47. In particular, the roughness of the two mating annular surfaces have been designed to produce a desired number of micro-pockets of insulating air of a desired size between asperities in the surfaces. These micro-pockets may increase a thermal resistance (a.k.a., a contact resistance) to heat transfer between the surfaces, effectively creating thermal barrier 58. In one example thermal barrier 58 may have a contact resistance of about 0.1-0.5 m²° C./kW when exposed to a contact pressure of about 5 MPa. Thermal barrier 58 has been designed, in combination with the thicknesses of liner 32 and ring 34, to provide a desired temperature at seal 30 during operation of engine 10. By doing so, the life of seal 30 may be extended and the likelihood of the coolant collected within recess 47 boiling may be reduced.

### INDUSTRIAL APPLICABILITY

The disclosed cylinder liner assembly may be used in any application where it is desired to increase the reliability and operating life of the associated engine. The disclosed cylinder liner assembly may increase reliability and operating life by lowering a temperature experienced by a seal installed on a cylinder liner of the assembly. This temperature may be lowered through the use of a uniquely designed thermal barrier located at an annular interface between the cylinder liner and an associated anti-polishing ring.

It will be apparent to those skilled in the art that various modifications and variations can be made to the disclosed cylinder liner assembly. Other embodiments will be apparent to those skilled in the art from consideration of the specification and practice of the disclosed cylinder liner assembly. It is intended that the specification and examples be considered as exemplary only, with a true scope being indicated by the following claims and their equivalents.

What is claimed is:

1. A cylinder liner assembly, comprising:
a liner having a hollow generally cylindrical body extending from a top end to a bottom end along a longitudinal axis, and an internal recess formed at the top end;
an anti-polishing ring disposed within the internal recess at the top end of the liner; and
a seal disposed around the liner at an internal axial end of the anti-polishing ring,
wherein a surface roughness of the internal recess together with a surface roughness of the anti-polishing ring creates a thermal barrier configured to maintain a desired temperature of the seal.

2. The cylinder liner assembly of claim 1, wherein the thermal barrier has a contact resistance of about 0.1-0.5 m²° C./kW when the anti-polishing ring and cylinder liner are exposed to a contact pressure of about 5 MPa.

3. The cylinder liner assembly of claim 2, wherein a roughness of an external annular surface of the anti-polishing ring is less than a roughness of an internal annular surface of the internal recess.

4. The cylinder liner assembly of claim 3, wherein the surface roughness of the anti-polishing ring is about ⅓-½ of the surface roughness of the internal recess.

5. The cylinder liner assembly of claim 4, wherein:
the surface roughness of the internal recess is about 6-10 μm; and
the surface roughness of the anti-polishing ring is about 2-6 μm.

6. The cylinder liner assembly of claim 5, wherein:
the surface roughness of the internal recess is about 6-9 μm; and
the surface roughness of the anti-polishing ring is about 3-3.5 μm.

7. The cylinder liner assembly of claim 2, wherein:
the surface roughness of the internal recess is associated with an inner annular surface; and
the surface roughness of the anti-polishing ring is associated with an outer annular surface that engages the inner annular surface.

8. The cylinder liner assembly of claim 2, wherein the liner and the anti-polishing ring are fabricated from the same material.

9. The cylinder liner assembly of claim 8, wherein the same material is an alloyed gray iron.

10. The cylinder liner assembly of claim 2, wherein the anti-polishing ring has a thickness about ⅙- 1/10 of a thickness of the liner at the anti-polishing ring.

11. The cylinder liner assembly of claim 10, wherein:
the thickness of the liner is about 10-25 mm; and
the thickness of the anti-polishing ring is about 1-4 mm.

12. The cylinder liner assembly of claim 1, wherein:
the liner further includes a flange connected to the hollow generally cylindrical body at the top end;
a coolant reservoir is formed at a location between the flange and the seal; and
the thermal barrier is configured to inhibit boiling of coolant within the coolant reservoir.

13. A cylinder liner assembly, comprising:
a liner having:
a hollow generally cylindrical body extending from a top end to a bottom end along a longitudinal axis and having a radial thickness of about 10-25 mm;
an internal recess formed at the top end;
a flange connected to the hollow generally cylindrical body at the top end; and
a coolant reservoir formed at an inside corner between the flange and the hollow generally cylindrical body;
an anti-polishing ring disposed within the internal recess at the top end of the liner and having a thickness of about 1-4 mm; and
a seal disposed around the liner at an internal axial end of the anti-polishing ring,
wherein:
a first surface roughness at an inner annular surface of the internal recess is about 6-9 μm;
a second surface roughness at an outer annular surface of the anti-polishing ring that engages the inner annular surface is about 3-3.5 μm; and
the first and second surface roughnesses create a thermal barrier having a contact resistance of about 0.1-0.5 m²° C./kW.

14. An engine, comprising:
a cylinder block at least partially defining a plurality of cylinder bores;
a cylinder liner assembly disposed within each of the plurality of cylinder bores; and
a water jacket formed between an annular wall of each cylinder liner assembly and a corresponding one of the plurality of cylinder bores,
wherein each cylinder liner assembly includes:
a liner having:
a hollow generally cylindrical body extending from a top end to a bottom end along a longitudinal axis;
an internal recess formed at the top end;
a flange connected to the hollow generally cylindrical body at the top end and configured to engage the cylinder block; and
a coolant reservoir formed at an inside corner between the flange and the hollow generally cylindrical body;
an anti-polishing ring disposed within the internal recess at the top end of the liner; and
a seal disposed around the liner at an internal axial end of the anti-polishing ring, between the water jacket and the coolant reservoir,
wherein a surface roughness of the internal recess together with a surface roughness of the anti-polishing ring creates a thermal barrier configured to maintain a desired temperature of the seal and to inhibit boiling of coolant within the coolant reservoir.

15. The engine of claim 14, wherein the thermal barrier has a contact resistance of about 0.1-0.5 m²° C./kW when the anti-polishing ring and cylinder liner are exposed to a contact pressure of about 5 MPa.

16. The engine of claim 15, wherein:
the surface roughness of the internal recess is about 6-9 μm; and
the surface roughness of the anti-polishing ring is about 3-3.5 μm.

17. The engine of claim 15, wherein the liner and the anti-polishing ring are fabricated from the same material.

18. The engine of claim 17, wherein the same material is an alloyed gray iron.

19. The engine of claim 15, wherein the anti-polishing ring has a thickness about ⅙- 1/10 of a thickness of the liner at the anti-polishing ring.

20. The engine of claim 19, wherein:
the thickness of the liner is about 10-25 mm; and
the thickness of the anti-polishing ring is about 1-4 mm.
